(19) United States
(12) Patent Application Publication
(10) Pub. No.: US 2004/0084128 A1
(43) Pub. Date: May 6, 2004

(54) Sunshade production method and production system

(76) Inventor: Mikimara Matsui, Toyota-shi (JP)

Correspondence Address: MURAMATSU & ASSOCIATES, Suite 225, 7700 Irvine Center Drive, Irvine, CA, 92618, US

(21) Appl. No.: 10/680,856

(22) Filed: Oct. 7, 2003

(30) Foreign Application Priority Data
Nov. 5, 2002 (JP) 2002-320786

(51) Int. Cl. B29C 65/00

(52) U.S. Cl. 156/60; 264/138; 264/248; 264/322; 425/295; 425/412

(57) ABSTRACT

A sunshade production method and system for producing a sunshade for use with a sunroof of a vehicle with high efficiency and low cost. The production method includes the steps of: cutting one side of a thermoplastic resin plate to create a base member of the sunshade; heating the base member to a predetermined temperature; overlapping a bottom surface of the heated base member with a surface material in a manner that one end portion of the surface material is extended from an end surface of the base member, pressure-forming the base member and the surface material overlapped with one another at the same time; wrapping the extended end portion of the surface material around the end surface of the base member; and removing unwanted portions of the base member and the surface material to finalize the sunshade.

### FIELD OF THE INVENTION

The present invention relates to a production method and production system of sunshades, and more particularly to a sunshade production method and production system for producing a sunshade for use with a sunroof of a vehicle with high efficiency and low cost.

### BACKGROUND OF THE INVENTION

A vehicle having a sunroof where air and sunlight coming through an opening of the sunroof is known. In general, a glass plate for blocking the wind and rain and a sunshade for blocking the sunlight are established at the opening of the sunroof. The glass plate and sunshade are supported by guide rails on the left and right sides of the opening, which have a U-shape in cross section, so that they can move forward and backward. In other words, when the glass plate and the sunshade are manually or electrically slid forward and backward along the guide rails, the opening will be closed or opened accordingly. When the opening is opened, the glass plate and the sunshade are stored in a storage space established at the bottom of a ceiling board of the vehicle.

When the sunshade is closed, the surface of the sunshade on the inner side of the vehicle becomes a part of the ceiling. Therefore, a sheet-like surface material made of the same material as the inner side surface of the ceiling is used for a bottom surface (inside the vehicle) of a resin base member that forms the sunshade. Particularly, the surface material is adhered not only to the bottom (inside) surface of the base member, but also to the tip (front end) of the sunshade that will be exposed when opened. The left and right sides as well as the back end of the sunshade will not be exposed because they are held by the guide rails or retainer (storage space) on the sunroof. However, because the front end is exposed when the sunshade is opened, the surface material is attached to the front end to improve the appearance as well as safety when touched by user's hands.

For producing the sunshades, the following method is known. First, a square shaped thermoplastic resin plate (base member) is heated, and then the base member is pressure-formed by a pressing machine. Next, one side of the base member is cut so that it can be formed in a predetermined shape (such as a semi-circular shape), and the three remaining sides are cut to match the size of the sunshade. A sheet-like surface material is then attached to the surface of the base member.

More particularly, the surface material is extended from the front end of the base member so that one end of the surface material is exposed, where the extended part then wraps around the front end of the base member toward the opposite surface. Through this procedure, a sunshade, where the bottom (inside) surface and the front end of the base material are attached with the surface material, is manufactured. In the above procedure, by attaching an adhesive film capable of heat welding to the surface of the base member in advance, the surface material can easily be adhered to the base member.

The above noted conventional technology is commonly used and known in the industry, although the applicant is not aware of any written materials describing this conventional technology.

In the foregoing production method, however, the process for pressure-forming the base member and the process for attaching the surface material to the base member are conducted separately, resulting in long work hours as well as many tools and equipment. Further, when, for example, a convex and concave are created on the base member in the pressure-forming process, such as a recess for placing user's fingers, it is extremely difficult to attach the surface material after forming such a recess.

Therefore, it is desirable that the pressure-forming process and the bonding process are conducted at the same. Namely, such a method is desired in which the adhesive film capable of heat welding is applied to the surface of the base member as well as the surface material is placed on the heated base member, and then the base member and the surface material are pressed at the same time to produced an integral molding. However, in this method, the extended part of the surface material for wrapping around the end of the base member will adhere to the other end of the base members that have to be cut off in the latter process. In such a situation, during the cutting process, a part of the surface material for wrapping needs to be separated from the part of the base member that will be removed, which is extremely difficult to do.

### SUMMARY OF THE INVENTION

The present invention has been made to solve the problems involved in the conventional technology, and it is an object of the present invention to provide a production method and production system for producing the sunshade with high efficiency and low cost.

It is another object of the present invention to provide a sunshade production method and production system in which an adhesion process and a pressure-formation process for the base member and surface material are conducted at the same time as one process.

It is a further object of the present invention to provide a sunshade production method and system in which a part of the surface material wraps around the front end of the base member and bonded to the other surface thereof without complicating the procedure.

The sunshade production method related to the first aspect of the invention is a method for producing the sunshade having a base member formed of a square shaped thermoplastic resin plate and a surface material that is attached to the entire surface of the base member where one end of the surface material is extended to wrap around the end of the base member. The sunshade production method is comprised of: a pre-cutting process for cutting one edge (front end) of the thermoplastic resin plate in a predetermined shape to create the base member, a heating process for heating the base member, an overlaying process for placing the surface material on the entire surface of the heated base member in a manner that one end of the surface material is extended from the edge (front end) of the base member cut in the pre-cutting process, a pressure-forming process for applying pressure on both the base member and the surface material at the same time to produce an integral molding, a wrapping process for wrapping the extended part of the surface material around the edge of the base member, and a cutting process for cutting the three remaining edges of the integral molding so that the integral molding matches the intended size of the sunshade.

In the process of cutting the edge of the thermoplastic resin plate in the pre-cutting process, the predetermined shape means a shape that matches the shape at the end of the sunshade when the base member after cutting is press-formed. This shape can also be formed by calculating the expansion ratio of the material of the base member from the shape at the end of the sunshade (completed shape), or by conducting several tests so that the integral molding will match the shape at the end of the sunshade.

The adhesion of the surface material in the pressure-forming process can be fulfilled by, for example, applying an adhesive film that is capable of heat welding to the surface of the base member in advance. Further, the adhesion of the extended part of the surface material in the wrapping process can be fulfilled by, for example, an ultrasonic welding device. Also, the cutting of the thermoplastic resin plate and the integral molding in the pre-cutting process and the cutting process can be fulfilled by, for example, using a water jet cutting machine, which cuts an object by shooting ultra-high pressure jet water.

The order of the wrapping process and cutting process is not limited to the particular example noted above. In other words, the three sides (edges) of the base member can be cut after wrapping the surface material around the front end, or vice versa.

According to the sunshade production method in the first aspect of the present invention, one side of the square-shaped thermoplastic resin plate is cut in a predetermined shape. Consequently, the base member having the shape corresponding to the part which is wrapped around by the surface material is created. Next, the base member is heated. Accordingly, the base member becomes a plastic state. In the case where an adhesive film that is capable of heat welding is applied to the base member, the adhesive film is also heated to be ready for welding. Then, the surface material is placed on the surface of the heated base member. In this case, the surface material covers the entire surface of the base member and further extends from the front end of the base member. In the case where an adhesive film is not provided to the surface of the base member in advance, an appropriate adhesive may be applied between the base member and the surface material.

In the next process, the base member and the surface material overlapped with one another are pressed by a pressing machine. As a result, the surface material is adhered to the bottom (inside of vehicle) surface of the base member, thereby forming an integral molding having a predetermined shape of the sunshade. For example, a recess for putting fingers in as well as bumps for improving the durability and ornamental effects are created through this process. Then, the extended part of the surface material on the integral molding is turned to wrap around the front end of the base member and bonded to the other surface of the base member. As a result, the front end of the base member is covered by the surface material. Then, the remaining three sides of the integral molding are cut to the intended size of the sunshade. Consequently, unnecessary parts will be removed from the integral molding, thereby achieving the intended size and shape of the sunshade.

The sunshade manufacturing method related to the second aspect of the present invention is to improve the sunshade manufacturing method in the first aspect noted above. In this invention, when cutting one side (front end) of the thermoplastic resin plate in the pre-cutting process, the surface of the front end of the thermoplastic resin plate is diagonally cut. As a result, an overall length of the top (outside) surface of the base member becomes larger than that of the bottom (inside) surface. Further, in the pressure-forming process, the part that has been diagonally cut in the pre-cutting process is bent toward the top (outside) side.

Since the front end of the base member may be touched by a driver's head or hands, the front end is preferably made comparatively thicker to improve safety. Thus, when forming the base member, the end portion is bent towards the top side (outside). Under this condition, at the bottom (inside) surface of the base member corresponding to an outer surface of the bent portion, a strength is exerted to an expanding direction, while at the top (outside) surface of the base member corresponding to an inner bent surface of the bent portion, strength is exerted to a shrinking direction. Thus, when material with a small expansion ratio, i.e., material with high heat-resistant dimensional stability, is used, tensile stress is exerted at the bottom surface of the base member due to the small expansion ratio during pressure-formation, resulting in difference in the degree of deformation. Thus, if the front end is cut to a flat surface, after being bent, the front end surface of the base member becomes inclined, i.e., a sharp edge, which adversely affects the safety.

However, according to the sunshade manufacturing method in the second aspect of the present invention, since the edge (front end) of the thermoplastic resin plate is cut in a diagonal direction so that the bottom (inside) surface is longer than the top (outside) surface. As a consequence, when the end portion having the end surface diagonally cut out is bent towards the top side (outside) by the pressure-formation, it compensates the difference of deformation between the top and bottom surfaces. Thus, the shape of the front end surface becomes a flat surface by the pulling of the bottom surface of the base member, i.e., the front end is prevented from becoming a sharp edge.

The third aspect of the present invention is a production system for implementing the production method in the first and second aspects noted above. The production system is comprised of a storage area for storing a plurality of base members prepared in the pre-cutting process, a heating chamber having a heating means for heating the base member to a predetermined temperature, a pressing machine for compressing the surface material and heated base member overlapped with one another, a picking means for picking and transferring the base member stored in the storage area one by one, a positioning means for positioning the base member brought by the picking means at a predetermined location, a retaining means for retaining both sides of the base member that has been positioned by the positioning means, and a transfer means for sequentially sending the base member retained by the retaining means to the heating chamber and pressing machine.

According to the sunshade production system in the third aspect of the present invention, a plurality of base members made of thermoplastic resin plate, where each of the base members is cut in a predetermined shape, are stored in the storage area. The base member is picked, one by one, by the picking means and placed on a predetermined location by the positioning means. Both sides of the base member are held by the retaining means. Then, the base member is transferred to the heating chamber by the transferring means and heated at a predetermined temperature. Further, the heated base member is transferred to the pressing machine. In the pressing machine, the surface material is laid out by workers for example, where the base member is placed on the surface material. By compressing both the base member and the surface material, an integral molding is created as a result of conducting both the bonding process and the pressure-forming process at the same time.

### BRIEF DESCRIPTION OF THE DRAWINGS

FIGS. 1(a)-1(d) are schematic diagrams showing the first half of the production process in the sunshade production method of the present invention.

FIGS. 2(a)-2(d) are schematic diagrams showing the second half of the production process in the sunshade production method of the present invention.

FIGS. 3(a)-3(d) are cross sectional views showing the structure of the major components of the sunshade for explaining the production method of the present invention.

FIG. 4 is a schematic plan view showing an example of structure of the sunshade production system in accordance with the present invention.

FIGS. 5(a)-5(b) are schematic diagrams showing the structure of the major components in the sunshade production system of the present invention.

### DETAILED DESCRIPTION OF THE INVENTION

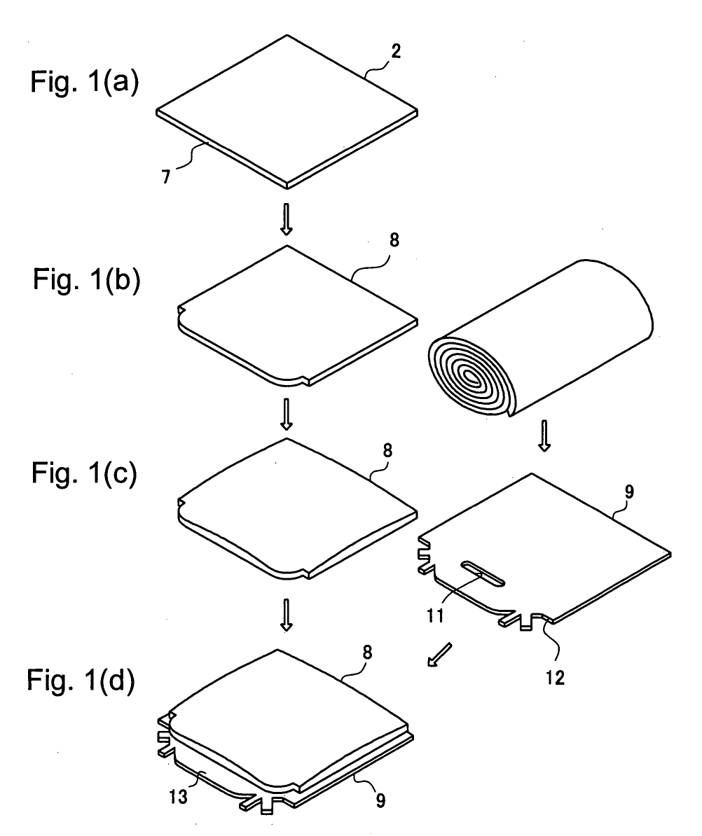

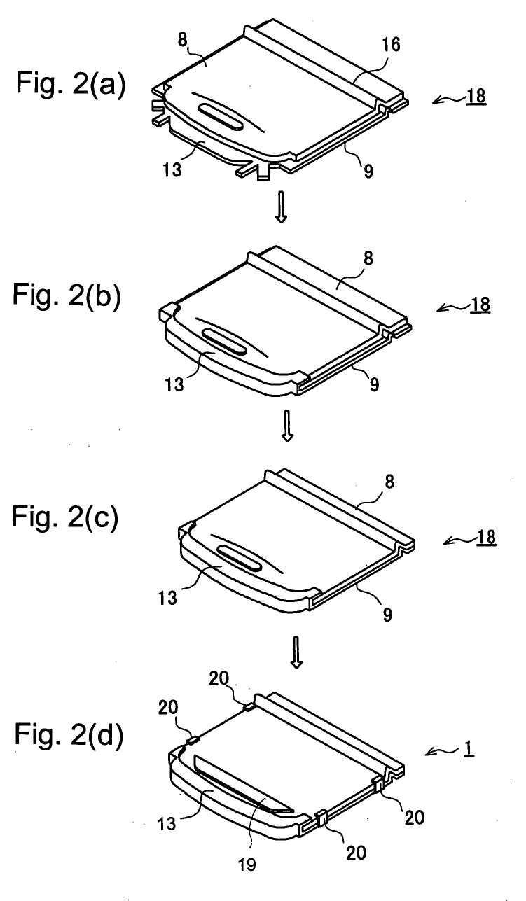

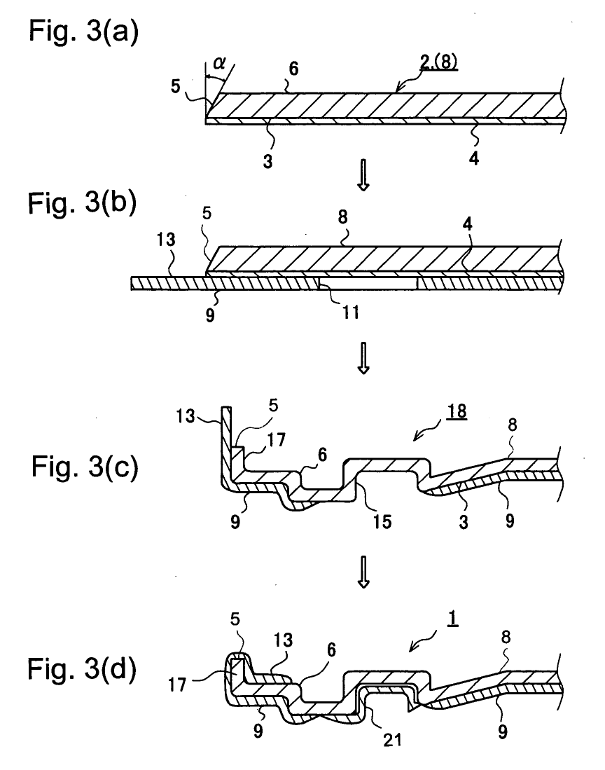

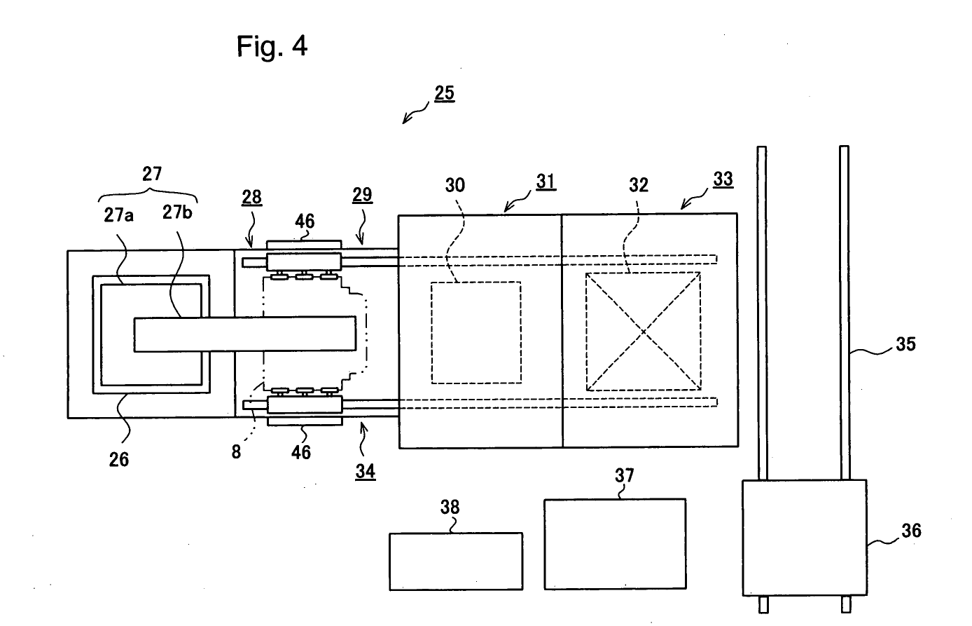

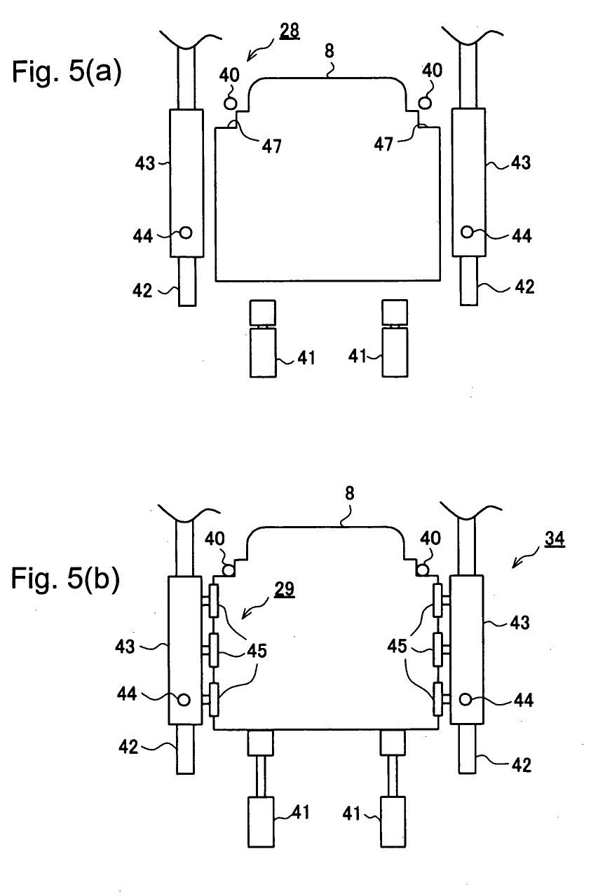

The sunshade production method of the present invention (hereafter, simply “production method”) and sunshade production system will be explained in the following with reference to FIGS. 1-5. FIGS. 1(a)-1(d) and 2(a)-2(d) are schematic diagrams showing the procedures involved in the production method, FIGS. 3(a)-3(d) are cross sectional views showing the configuration of the major components of the sunshade involved in the production process, FIG. 4 is a plan view showing a schematic configuration of the sunshade production system for implementing the manufacturing method of the present invention, and FIGS. 5(a)-5(b) are an explanatory views showing the configuration of the major components of the production system.

The sunshade 1 produced by the production method of the present invention (FIG. 2(d)) is installed at an opening of a sunroof (not shown) of a vehicle, where the sunlight is blocked when the opening of the sunroof is closed. When installed in the sunroof, the sunshade 1 is supported by guide rails formed on the left and right sides of the opening so that it can slide forward and backward along the guide rails. The sunshade 1 is mainly comprised of a base member 8 formed of thermoplastic resin plate 2 and a surface material 9 that is adhered to the base member 8.

The sunshade 1 is manufactured through several processes, for example, in the order of a pre-cutting process, a heating process, an overlaying process, a pressure-forming process, a wrapping process, a cutting process, and an assembling process. Each process will be explained in detail below.

First, in the pre-cutting process, as shown in FIGS. 1(a) and 1(b), a side 7 of a square-shaped thermoplastic resin plate 2 is cut in a predetermined shape, namely, in the shape that will achieve the intended shape of the front end of the sunshade 1 after the pressure-forming process. As a result of this pre-cutting process, the base member 8 is created.

In the pre-cutting process, as shown in FIGS. 3(a)-3(b), an end surface (may also be referred to as “front end”) 5 of the thermoplastic resin plate 2 is cut in a diagonal direction so that a length of a bottom surface 3 (inner side of the vehicle) of the thermoplastic resin plate 2 (base member 8) becomes longer than that of a top surface 6 (outer side of the vehicle). This is done so because when an end portion 17 of the base member 8 is bent towards the top side (outer side of the vehicle) as shown in FIG. 3(c) through the pressure-forming process (explained hereafter), the end surface 5 will not have a sharp edge but will become a flat surface.

In contrast, if the end surface 5 is cut in a vertical direction of FIG. 3(a), tensile stress will be exerted only on the bottom surface 3 during the pressure-formation process because of different degrees of deformation between the top surface and the bottom surface of the base member 8 (thermoplastic resin plate 2), which results in a sharp edge on the end surface 5. However, in the present invention, because the length of the bottom surface 3 is longer than that of the top surface 6, the end surface 5 becomes flat after the pressure-forming process as in FIG. 3(c) by compensating the difference of deformation. The cutting angle is not limited to a specific number, but rather individually set according to the cut shape and the bent angle in the left and right direction.

The thermoplastic resin plate 2 is configured by a sheet-like material including, for example, glass fibers to meet rigidity and heat resistance requirements. Due to its hardness, a water jet cutting machine is preferably used for cutting the thermoplastic resin plate 2. In the preferred embodiment of the present invention, the thermoplastic resin plate 2 is formed of composite material comprising of about 40% of glass fibers in a polypropylene resin. The composite ratio is adjusted so that when this material is heated at the temperature where the resin will soften, it will expand by repulsion of the glass fibers.

On the bottom (inside) surface 3 of the thermoplastic resin plate 2 (base member 8), an adhesive film 4 that is capable of heat welding is preferably applied. In other words, by heating the adhesive film 4, the surface material 9 will be adhered to the bottom surface 3 of the thermoplastic resin plate 2 (base member 8).

In the heating process, the base member 8 is heated in the heating chamber (explained hereafter). Here, the heating time and heating temperature are not limited to particularly values. In the embodiment of the present invention, the base member 8 is heated for 10 seconds in the heating chamber with an environmental temperature of about 200 degrees centigrade. By heating the base member 8 in such a condition, the base member 8 slightly expands as shown in FIG. 1(c), on which the pressure-formation process is conducted.

In the overlaying process, as shown in FIG. 1(d) and FIG. 3(b), the base member 8 and the surface material 9 overlap with one another in the metal mold of the pressing machine. At this time, the surface material 9 covers the entire bottom surface 3 of the base member 8, and a portion 13 of the surface material 9 is extended from the front end (end surface, i.e, a part corresponding to front edge of the sunshade 1) of the base member 8. The surface material 9 is formed by cutting a decorative belt-like material (the same material as that of the ceiling of the vehicle) that is rolled up (FIG. 1(b)). When cutting the surface material, if necessary, an opening 11 and notches 12 may also be formed (FIG. 1(c)).

In the pressure-forming process, the base member 8 and the surface material 9 that have been overlaid together are pressed at the same time in the metal mold of the pressing machine. As a result, as shown in FIGS. 2(a) and 3(c), the surface material 9 is adhered to the bottom surface 3 of the base member 8, and at the same time, a predetermined shape is formed, which creates an integral molding 18. In the example of FIG. 3(c), a recess 15 at the center of the front end for allowing the user's fingers to fit in, a bump 16 extended to the left and right direction, and an end portion 17 which is bent upwardly (toward the top surface 6) are respectively formed by the pressure-forming process. The portion 13 of the surface material 9 extended from the front end 5 of the base member 8 projects higher than the end surface 5.

In the wrapping process, as shown in FIGS. 2(b) and 3(d), the end surface 5 (at the tip of the end portion 17) is wrapped around by the extended portion 13 of the surface material 9. The end of the extended portion 13 is adhered to the top surface 6 of the base member 8. Numeral 21 indicates a surface material attached to the recess 15 and is preferably created in the wrapping process. In the wrapping process, a finishing tool for putting a pressure on the extended portion 13 toward the top surface 6, and an ultrasonic welding device for bonding the extended portion 13 to the top surface 6 will be used.

In the cutting process, as shown in FIG. 2(c), the three remaining sides of the integral molding 18 are cut out to match the intended size of the sunshade 1. In other words, the surroundings are cut so that the sides can be fitted in the guide rails of the sunroof. In this situation, since the surface material 9 is also cut at the same time, the end surface of the base member 8 and the end surface of the surface material 9 are flashed to one another. Although the left and right sides as well as the back edge of the base member 8 are exposed, these parts will not be shown because they are hidden in the guide rails and the storage area of the sunroof when installed.

Lastly, in the assembling process, as shown in FIG. 2(d), attachment members 19 and 20 required for attaching the sunshade 1 to the sunroof are mounted on the upper surface and the sides of the integral molding 18, which completes the sunshade 1.

Next, a sunshade production system 25 for implementing the above described production method will be briefly explained. This production system 25 automates the heating process, the overlaying process, and the pressure-forming process described in the foregoing, As shown in FIG. 4, the production system 25 is comprised of a storage area 26, a picking device 27, a positioning device 28, a retainer 29, a transferring device 34, a heating chamber 31, and a pressing machine 33.

The storage area 26 stores a plurality of base members 8 that have been prepared in the pre-cutting process. The base members 8 are, for example, piled in the storage area 26. The picking device (picking means) 27 picks the base member 8 at the top on the pile in the storage area 26. The picking device 27 includes a pulley unit 27a to establish an up and down movement to pick the base member, and a transferring unit 27b to move the pulley unit 27a between the storage area 26 and the positioning device 28.

The positioning device (positioning means) 28 places the base member 8 that has been transferred by the picking device 27 on a predetermined position. As shown in FIG. 5(a), the positioning device 28 is comprised of first positioning pins 40 for contacting with the base member 8 and a pressing means 41 for pressing the base member 8 toward the first positioning pins 40. Each of the first positioning pins 40 is placed in the space corresponding to the space for each corner 47 at the front end of the base member 8. The pressing means 41 having a cylinder is established at the back end of the base member 8. The first positioning pins 40 and the pressing means 41 are supported so that they can be moved up and down.

Thus, when positioning the base member 8 received from the picking device 27, the first positioning pins 40 and the pressing means 41 are raised to the height of the base member 8, where the pressing means 41 presses the base member 8 toward the first positioning pins 40. As a result, the corners 47 of the base member 8 come in contact with the pair of first positioning pins 40 and held between the first positioning pins 40 and the pressing means 41. Accordingly, the forward and backward position as well as the left and right position of the base member 8 (FIG. 5(b)) are defined by the positioning device 28.

The retainer (retaining means) 29 retains the base member 8. As shown in FIG. 5(b), the retainer 29 is comprised of a plurality of chucks 45 for holding the left and right edges of the base member 8 in an up and down direction, and actuators 46 (FIG. 4) for driving the chucks 45 between an open state (releasing motion) and a close state (holding motion). Thus, by the actions of the chucks 45 and actuators 46, the retainer 29 holds the base member 8 at the position determined by the positioning device 28. The base member 8 retained by the retainer 29 is transferred to the heating chamber 31 and to the pressing machine 33 by the transferring device 34, and is released at the pressing machine 33.

The transferring device (transferring means) 34 sequentially transfers the retained base member 8 to the heating chamber 31 and the pressing device 33. In FIG. 5(b), the transferring device 34 is comprised of sliders 43 having one or more chucks 45, guide rails 42 extended in a straight line from where the positioning is conducted to where the pressing machine 33 is located, and a driving means (not shown) for moving the sliders 43 along the guide rails 42. The sliders 43 and the guide rails 42 are positioned by second positioning pins 44 which move in an up and down direction.

In other words, by retaining the base member 8 at the predetermined position, the relative position with the guide rails 42 and the base member 8 is established. Further, although not shown, positioning means corresponding to the second positioning pins 44 are also provided at the pressing machine 33, thereby positioning the guide rails 42 and the sliders 43 at the pressing machine 33. Consequently, the base members 8 can always be brought to the same position of the metal mold 32 of the pressing machine 33.

The heating chamber 31 is a space provided with a heating means 30, and its temperature is controlled to about 200 degrees centigrade. Since only the left and right edges of the base member 8 are held in such a way that the entire base member 8 is floating, the adhesive film 4 that is applied to the bottom surface 3 will not contact with other materials or components when it melts by the heat.

The pressing machine 33 compresses the surface material 9 and the heated base member 8 superposed with one another at the same time. The pressing machine 33 includes a pair of molds 32, i.e., an upper mold and a lower mold. The surface material 9 is provided on the lower mold, for example, manually by a worker. The base member 8 transferred by the transferring device 34 is inserted between the pair of molds 32, and placed on the surface material 9 on the lower mold when released from the retainer 29. Namely, by providing the surface material 9 on the lower mold before the base member 8 is placed thereon, the base member 8 and the surface material 9 will then overlap with one another, thereby allowing to pressure-form the both at the same time.

In the sunshade production system 25, in addition to the above mentioned devices, other auxiliary devices are also included, for example, a mold replacement device having guide rails 35 and a replacement mold carrier 36, a hydraulic unit 37 for supplying hydraulic pressure to each device, and a control board 38 for electrically controlling each device.

In the above production method of the present invention, since the adhesion and pressure formation of the surface material 9 and the base member 8 are conducted at the same time as one process, one of the conventional steps is eliminated and the equipment is simplified. Particularly, by cutting the side 7 of the thermoplastic resin plate 2 before the pressure formation, the integral molding 18 can be manufactured without having the extended portion 13 of the surface material 9 adhere to a part of the bottom surface 3 of the base member 8 to be removed. Accordingly, it is possible to easily wrap the extended portion 13 around the end surface 5 of the base member 8 toward the top surface 6. Therefore, the burden on the workers involved in the conventional technology is eliminated and productivity is improved.

Further, in the production method described above, when cutting the side 7 of the thermoplastic resin plate 2, the end surface 5 of the base member 8 is diagonally cut. This is effective in preventing from causing a sharp edge when the end portion is bent in the case where the material of the thermoplastic resin plate 2 has a small expansion ratio. As a result, the safety for the user is improved and the appearance is enhanced as well. In addition, since the end surface 5 contacting the wrapped part of surface material 9 is not sharp, the durability can be increased.

Moreover, in the above production system 25, the relative position of the base member 8 in the pressing machine 33 can be accurately regulated by the positioning device 28 and the retainer 29. Accordingly, the transfer of the base member 8 to the pressing machine 33 can be automated, which will improve the production efficiency. Also, since the heated base member 8 does not have to be handled manually, the safety of the workers can be secured.

Although the invention is described herein with reference to the preferred embodiments, one skilled in the art will readily appreciate that various modifications and variations such as the followings may be made without departing from the spirit and the scope of the present invention.

In the above embodiment of the production method, the cutting process is conducted after the wrapping process, however, it can also be conducted before the wrapping process. Namely, since the part (end surface 5) for wrapping the extended portion 13 and the other three sides are not overlapped with one another, the order of those processes can be appropriately set based on specific situations such as layout of the equipment.

Further, in the above embodiment of the production method, the surface material 9 is provided to the mold manually, however, it can be automatically supplied with use of a carrying device such as an automatic handler. However, unlike the base member 8, since the surface material 9 is not heated to a high temperature, the burden and the risk of harm to the workers are very small. Thus, basically there is no problem in conducting this process by manual works, and it may even allow the equipment to be smaller.

Moreover, in the above embodiment of the production method, the materials including the glass fibers are used for the thermoplastic resin plate, however, a thermoplastic resin plate without including the glass fibers can also be used. However, by using the material including the glass fibers, the sunshade 1 with superior heat resistant dimensional stability can be achieved, allowing the sunshade 1 to open and close smoothly.

As has been foregoing, in the sunshade production method of the present invention, the two conventional processes are conducted at the same time, thereby eliminating the time required for one process as well as simplifying the equipment. Particularly, by cutting only one side of the thermoplastic resin plate in a predetermined shape in advance, the extended portion of the surface material will not adhere to the thermoplastic resin plate that is not used for the base member, enabling to produce the integral molding. As a consequence, the part of the surface material can be wrap around the end surface of the base member without complicating the work.

Further, the sunshade manufacturing method of the present invention is able to manufacture the base member without a sharp end, thereby improving the safety of the user as well as improving the appearance. The durability of the surface material can be improved as well.

Further, the sunshade production system of the present invention is able to efficiently implement the sunshade production method of the present invention described in the foregoing and to reduce the burden on the workers by automating the production process.

What is claimed is:

1. A method for producing a sunshade for use with a sunroof of a vehicle, comprised of the following steps of:
cutting one side of a thermoplastic resin plate in a predetermined shape to create a base member of the sunshade;
heating said base member to a predetermined temperature;
overlapping an entire bottom surface of the heated base member with a surface material in a manner that one end portion of said surface material is extended from an end surface of said base member created in said cutting step;
pressure-forming said base member and said surface material overlapped with one another at the same time to create an integral molding;
wrapping said extended end portion of said surface material around said end surface of said base member of said integral mold; and
removing unwanted portions of the base member and the surface material from the integral molding by cutting three remaining sides of said integral molding to finalize the sunshade.

2. A method for producing a sunshade as defined in claim 1, wherein said step of cutting said one side of said thermoplastic resin plate diagonally cuts said end surface so that a length of a bottom surface of said base member where the surface material is to be overlapped is longer than a top surface thereof, and wherein said step of pressure-forming bends a front portion of said base member having said end surface toward said top surface.

3. A method for producing a sunshade as defined in claim 2, wherein said end surface diagonally cut in said cutting step becomes a flat surface after being bent toward said top surface after said pressure-forming step.

4. A method for producing a sunshade as defined in claim 2, wherein said step of wrapping said extended end portion of said surface material includes a step of bonding an end of said extended end portion to said top surface of said base member after wrapping said end surface of said base member.

5. A method for producing a sunshade as defined in claim 1, further comprising a step of applying an adhesive between said base member and said surface material before the step of heating said base member.

6. A method for producing a sunshade as defined in claim 1, further comprising a step of applying an adhesive film for heat welding on said base member before overlapping said surface material on said base member.

7. A sunshade production system for producing a sunshade for use with a sunroof of a vehicle, comprising:
a storage for storing a plurality of base members of the sunshades prepared by cutting a thermoplastic resin plate;
a heating chamber for heating said base member to a predetermined temperature;
a pressing machine for compressing surface material and said heated base member overlaid on said surface material at the same time;
a picking means for picking said base member stored in said storage one by one;
a positioning means for positioning said base member brought by said picking means at a predetermined position of the sunshade production system;
a retaining means for retaining both sides of said base member that has been positioned by said positioning means; and
a transferring means for sequentially transferring said base member retained by the retaining means to said heating chamber and to said pressing machine.

8. A sunshade production system as defined in claim 7, wherein said base member created by cutting said thermoplastic resin plate has an end surface which is diagonally cut so that a length of a bottom surface of said base member where the surface material is to be overlapped is longer than a top surface thereof, and wherein said pressing machine bends a front portion of said base member having said end surface toward said top surface.

9. A sunshade production system as defined in claim 8, wherein said end surface of said base member diagonally cut becomes a flat surface after being bent toward said top surface by said pressing machine.

10. A sunshade production system as defined in claim 8, wherein an end of said extended end portion of said surface material is bonded to said top surface of said base member after wrapping said end surface of said base member.

11. A sunshade production system as defined in claim 7, wherein an adhesive is applied between said base member and said surface material before said base member is heated in said heating chamber.

12. A sunshade production system as defined in claim 7, wherein an adhesive film for heat welding is applied on said bottom surface of said base member before overlapping said surface material on said bottom surface.

13. A sunshade production system as defined in claim 7, wherein said pressing machine includes a mold configured by an upper mold and a lower mold where said surface material is laid on said lower mold and said base member heated by said heating chamber is placed on said surface material before said upper mold and said lower mold compress said base member and said surface material.

14. A sunshade production system as defined in claim 7, wherein said picking means includes means for picking said base member by moving in an up and down direction and means for transferring said base member that has been picked-up to said positioning means.

15. A sunshade production system as defined in claim 7, wherein said positioning means includes positioning pins to contact with said base member and a pressing means for pressing the base member toward said position pins, thereby positioning said base member between said positioning pins and said pressing means.

16. A sunshade production system as defined in claim 7, wherein said positioning means includes positioning pins to contact with said base member and a pressing means for pressing the base member toward said position pins thereby positioning said base member between said positioning pins and said pressing means, and wherein said positioning pins and said pressing means are movable in an up and down direction so that said base member is floated when being positioned by said positioning means.

17. A sunshade production system as defined in claim 7, wherein said retainer includes chucks for holding said base member at its sides and actuators for driving said chucks to hold or release said base member.
